(19) United States
(12) Patent Application Publication
(10) Pub. No.: US 2006/0290110 A1
(43) Pub. Date: Dec. 28, 2006

(54) Interior panel part for motor vehicles and a method of manufacturing such an interior panel part

(75) Inventors: Rudolf Diemer, Alsheim (DE); Holger Reusswig, Dietzenbach (DE); Gunther Grubler, Russelsheim (DE)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI (US)

(21) Appl. No.: 11/450,733

(22) Filed: Jun. 9, 2006

(30) Foreign Application Priority Data
Jun. 10, 2005 (DE) 10 2005 026 906.0

(51) Int. Cl. B60R 21/215; B23K 26/00

(52) U.S. Cl. 280/728.3; 219/121.72; 219/121.69

(57) ABSTRACT

An interior panel part for motor vehicles, with at least one breaking line for exposing an opening when an air bag is released, which breaking line is defined by cuts on the side of the interior panel part lying opposite a visible surface, and material bridges are also provided between these cuts. The invention is distinctive due to the fact that at least one of the material bridges is wedge-shaped so that it has an undercut in the direction of the breaking line and the slim end of the wedge shape is directed towards the visible surface of the panel part. The invention further relates to a method of manufacturing such an interior panel part.

### BACKGROUND OF THE INVENTION

1. Field of the Invention

The present invention relates to an interior panel part for motor vehicles and to a method of manufacturing an interior panel part for motor vehicles. The interior panel part in this case may be any panel part used to cover an air bag, for example a seat component, a dashboard, door interior panel or panels of vehicle pillars.

2. Background Art

An interior panel part of the generic type and a manufacturing method of the generic type are known from patent specification DE 199 450 22 A1. In it a laser processing system is disclosed as a means of producing intended weak points or breaking points in panel parts. The emphasis of the teaching contained in this publication is the fact that the thickness of the rest of the material in the region of the laser cut is measured in order to obtain a defined depth of the cuts. To ensure that the processed workpiece has to be moved as little as possible, a scanner mirror system is provided, by means of which the laser beam can be directed to different points on the workpiece. Patent specification DE 199 450 22 A1 also mentions that if undercuts are made at the holes produced by the laser, the holes will have smaller dimensions on the top face of the workpiece than in their interior, making them less perceptible.

Although the known manufacturing method seems suitable as a means of creating weak points in interior panel parts in a defined manner, there is still room for improvement in terms of the way in which the air bag devices provided on them open.

### SUMMARY OF THE INVENTION

The objective of the present invention is to provide interior panel parts and a method of manufacturing such interior panel parts which exhibit better definable opening behavior than the known interior panel parts.

As proposed by the invention, wedge-shaped material bridges are provided along the breaking line formed in the interior panel part by cuts. Their purpose is to ensure that an air bag flap defined by the breaking line remains intact within the panel part until the air bag is released. For the purpose of the invention, a wedge shape is imparted to these material bridges so that they have an undercut in the direction of the breaking line and the narrow end of the wedge shape is directed towards the visible surface of the panel part. This design of material bridges simultaneously offers several advantages. The broad base of the wedge-shaped material bridges lies on the side of the interior panel part associated with the air bag. Since it is from this side that force is transmitted to the material bridge when the air bag is released, the wedge shape of the material bridge directs the transmitted force to its tip so that the tip of the wedge severs the remaining material thickness of the interior panel part and the breaking line is opened at this point. As the air bag opens, the wedge-shaped material bridge in fact undergoes a shearing motion because the material bridge between the air bag flap as it opens and the remaining region of the panel part which is stationary is fixed. During this shearing movement, the wedge is able to turn or tilt easily so that instead of having a “cutting edge” directed towards the visible surface, a “cutting tip” is imparted to it at its narrow end, which is able to sever the remaining material of the panel part in a more effective and defined manner at the breaking line.

Conversely, the breaking line should be destroyed only when an air bag is released and not merely due to the fact that a passenger is leaning on the interior panel part in the region of the breaking line. Advantageously, the wedge-shaped material bridge also satisfies this requirement. It does so because even if a passenger leans against the external face of the interior panel part, he transmits force firstly into the tip of the wedge-shaped material bridge. From there, the force is transmitted to the broader base of the wedge shape where the material bridge has a large surface area on which the surrounding material is supported. This support prevents the material bridge from moving, which might otherwise cause the breaking line to tear open, which is not desirable. In actual fact, the breaking line is effectively only destroyed when the air bag is released.

The material bridge preferably has undercuts not just on one but on both of its sides in the direction of the breaking line. This further assists opening of the air bag flap in a defined manner because the forces transmitted to the wedge as the air bag opens are even more intensively concentrated.

In this connection, the material bridge is ideally symmetrical so that its mid-plane is specifically oriented perpendicular to the visible surface of the panel part. The forces transmitted to the material bridge as the air bag opens are directed directly outwards to the degree that the interior panel part opens more quickly along the breaking line.

The thickness of the panel part may also be slightly slimmer at the material bridge than the original thickness of the panel part outside of the cuts as measured from the visible surface. However, it is better if the thickness of the panel part is exactly the same size at a material bridge as in the regions outside of the cuts because this means that the material bridge will be securely retained between the air bag flap and the region of the interior panel part surrounding it.

In a preferred variant, the interior panel part comprises several layers of different materials, in particular a relatively strong base layer, a foam layer for damping sound, absorbing impact energy and creating a pleasant tactile impression, and in addition or alternatively an outer layer. This may serve as a decorative surface for the interior panel part.

If the material bridge has the same arrangement of material layers as the adjacent region of the panel part, the interior panel part proposed by the invention can be manufactured particularly easily. This being the case, the panel part can firstly be manufactured with a uniform material thickness before the cuts are then made, leaving material bridges between them.

As an alternative, it would also be conceivable for the wedge-shaped material bridges to be made from a different material from the adjacent region of the panel part. Although this variant would be somewhat more complex in terms of manufacture, it nevertheless offers other advantages in terms of achieving defined opening behavior of the air bag flap because the material bridge can be made from a material that is specifically suited to severing the breaking line. Such an interior panel part could be manufactured for example by firstly providing the desired material of the material bridge along the entire breaking line in the same material thickness as the remaining region of the panel part, and then producing the cuts in this material and leaving the material bridges behind.

If the interior panel part has a strong base layer, for example on its side remote from the visible surface, the interior panel part will be particularly easy to manipulate and transport during assembly. In addition, the base of the material bridge can then be made from the same strong material as the base layer. The advantage of this is that the material bridge will be particularly capable of withstanding stress introduced from outside, for example due to a passenger leaning on the breaking line, without the interior panel part opening along the breaking line.

If the interior panel part has an outer layer forming the visible surface, a cut may extend as far as this outer layer, at least in certain regions. As the air bag opens, only this relatively thin outer layer will then have to be torn open, which is conducive to the opening behavior of the air bag flap. The opening behavior can be further enhanced if the cut actually extends into the outer layer so that this outer layer is also made slimmer in its material thickness. This further reduces the amount of force needed for opening purposes.

A hinge portion is preferably provided between two points of the breaking line. The air bag flap can turn about this hinge portion in a defined manner when the air bag is released. The hinge portion simultaneously secures the air bag flap to the interior panel part, thereby preventing loose parts from flying around undesirably as the air bag is released. Even bits of the material bridges are not able to fly around because they either remain attached to the air bag flap or to the region of the interior panel part surrounding it.

Cuts of differing length may be made along the breaking line. This offers another way of being able to influence the opening behavior of the air bag flap. The longer the cuts are, the fewer material bridges there will be on a specific portion of length and the easier and more quickly the breaking line will be torn open along this portion.

It would be conceivable, for example, to provide perforation-shaped and/or linear cuts along the breaking line. In the case of perforation-shaped cuts, there would then be more material bridges than would be the case with linear cuts, and the breaking line would therefore open earlier in the region of the linear cuts.

It is of practical advantage if the breaking line is slightly U-shaped and has linear cuts, whereas a hinge portion with perforation-shaped cuts is provided between the two end points of the U-shaped breaking line. The advantage of this in terms of manufacturing is that the hinge portion and the breaking line can be produced using the same method and only the shape of the cuts has to be varied.

With a view to obtaining a defined opening behavior of the air bag flap, every cut may have a constant depth. The opening behavior of the air bag flap will then be determined by nothing more than the length of the cuts and the length of the material bridges lying in between.

The invention also relates to a method of manufacturing an interior panel part for motor vehicles. This method involves making an interior panel part which may initially have a constant material thickness, for example, and using a tool to produce an undercut in the direction of the breaking line on at least one material bridge so that the material bridge assumes a wedge-like shape. The advantage of performing work subsequently on a preformed blank for the interior panel part is that the undercuts can be produced more effectively.

In principle, the finishing work on the interior panel part may be done using any tool which is capable of weakening the material whilst simultaneously producing undercuts. Appropriately disposed blades would be one option, for example. However, a laser beam is an easier tool to manipulate, by means of which material can be removed form the panel part along the cuts. The exact mechanism by which material is removed will depend on the type of laser used in each case. For industrial purposes, a CO₂ laser may be used, for example.

A scanner mirror system may be provided as a means of controlling this laser beam, in order to vary the orienting beam relative to the interior panel part in order to produce the undercuts. As the workpiece is moved relative to the processing head of the laser and/or the processing head of the laser is moved relative to the workpiece, the laser beam can be set by means of the scanner mirror so that it hits the workpiece at an angle and thus produces an undercut.

An adjustable focussing system may also be provided for the laser beam, by means of which the focal point of the laser beam can be held at a constant depth in the interior panel part as the cuts are produced. Since material is removed by the laser predominantly at the focal point of the laser beam, a cut of constant depth can be produced.

### BRIEF DESCRIPTION OF THE DRAWINGS

FIG. 1 shows a plan view of a part of an interior panel part proposed by the invention.

FIG. 2 shows a perspective view of a portion of the breaking line of the interior panel part illustrated in FIG. 1 at the point denoted by II in FIG. 1.

FIG. 3 shows a part of the interior panel part illustrated in FIG. 1 at the point denoted by III in FIG. 1.

FIG. 4 is a schematic diagram illustrating the method of producing an interior panel part proposed by the invention and a vertical section through a part of this interior panel part.

The same reference numbers are used to denote identical components consistently in all the drawings.

### DETAILED DESCRIPTION OF THE PREFERRED EMBODIMENT(S)

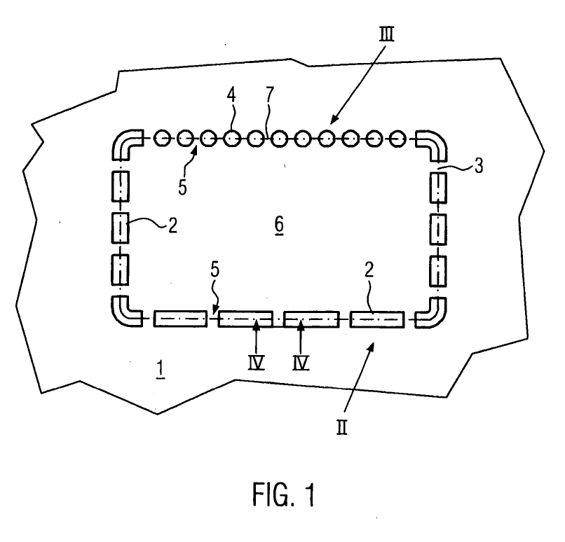

FIG. 1 shows a plan view of a part of an interior panel part 1 for motor vehicles, which interior panel part 1 is intended as a cover for an air bag (not illustrated) lying behind it. The interior panel part 1 may be a dashboard, a door interior panel or a B or C pillar panel, for example.

FIG. 1 illustrates the side of the interior panel part 1 remote from the visible surface, i.e. the side facing the air bag. A series of elongate or curved cuts 2 is provided in the interior panel part 1 on this side so that the thickness of the interior panel part 1 is reduced at these points. The cuts 2 are disposed so that, together, they form a breaking line 3 with an approximately U-shaped contour.

Perforation-shaped cuts or recesses 4 are provided in the interior panel part 1 on the connecting line between the two end points of the U-shaped breaking line 3. Both between the elongate cuts 2 and also between the perforation-shaped cuts 4, material bridges 5 exist at which the interior panel part 1 is not reduced in its thickness. These material bridges ensure that an approximately rectangular-shaped air bag flap 6 surrounded by the elongate cuts 2 and the perforation-shaped cuts 4 remains attached to the surrounding region of the interior panel part 1.

For each lengthwise portion, more material bridges 5 are provided on the side of the air bag flap 6 with the perforation-shaped cuts 4 than along the U-shaped breaking line 3. For this reason, the air bag flap 6 is stronger on this side, by which it is attached to the surrounding interior panel part 1, than at the other edges. When the air bag is released in the event of an impact of the vehicle and pushes from inside against the air bag flap 6, the air bag flap 6 will tear away from the interior panel part 1 at its weakest point, namely along the breaking line 3. Due to the stronger attachment of the air bag flap 6 between the two end points of the breaking line 3, this section can now act as a hinge portion 7 about which the air bag flap 6 pivots as it opens. The perforation-shaped cuts 4 therefore ensure that the hinge portion 7 is sufficiently deformable, whilst the material bridges 5 between the perforation-shaped cuts 4 continue to ensure that the air bag flap 6 is securely attached to the interior panel part 1. This prevents the air bag flap 6 or other loose parts flying around in the vehicle as the air bag opens.

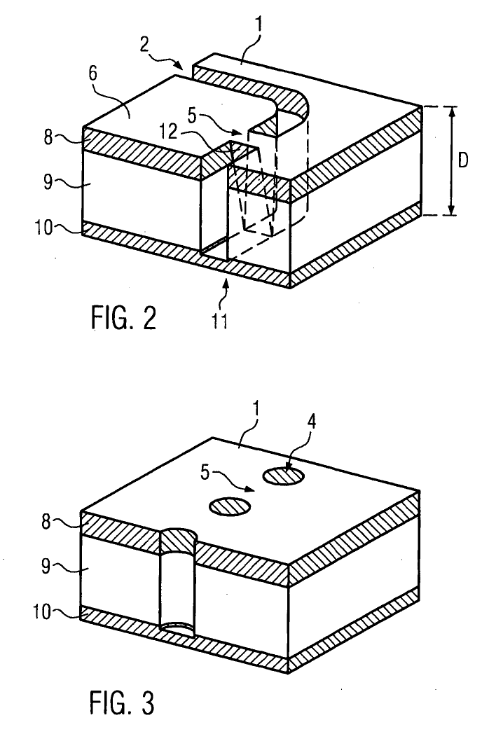

FIG. 2 shows a perspective view of the interior panel proposed by the invention at the point denoted by II in FIG. 1, i.e. in a corner of the U-shaped breaking line 3.

The interior panel part 1 in this embodiment is made up of three layers of material. Its side facing the air bag is made from a base or substrate layer 8, which imparts strength to the interior panel part 1. To this end, the base layer 8 may be made from a thermoplastic material, for example. Adjoining the base layer 8 is a foam layer 9, for example a soft foam so that the interior panel part has pleasant tactile properties for the passenger. Adjoining the foam layer 9 is an outer layer 10, which forms the outer visible surface of the interior panel part and thus determines the appearance of the interior panel part 1 for the passenger. The outer layer 10 may be a relatively flexible material. The base layer 8, the foam layer 9 and the outer layer 10 are joined to one another, in which case the interior panel part 1 may be made as a multi-layered article overall.

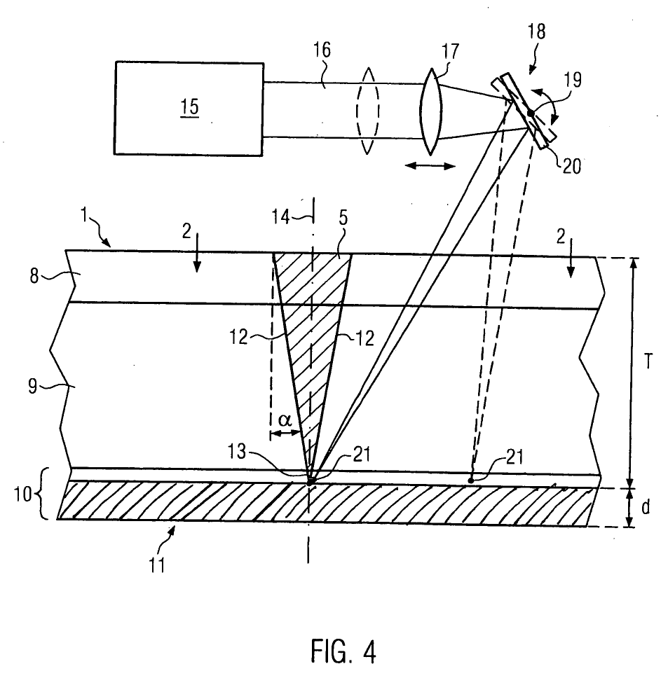

The cuts 2 illustrated in FIG. 2 extend from the internal face of the interior panel part 1 and run through the base layer 8, through the foam layer 9 and into the outer layer 10. The original material thickness D of the interior panel part 1 is therefore reduced to a material thickness d at the cuts 2 (see also FIG. 4), which is slimmer than the original material thickness of the outer layer 10. As a result of this thinner material, the cuts 2 form the breaking line 3 along which the air bag flap 6 is able to tear away from the surrounding region of the interior panel part 1.

As may be seen from FIG. 2, the material bridge 5 between the linear cuts 2 is wedge-shaped and has undercuts 12 directed in the longitudinal direction of the breaking line 3, i.e. directed towards the cuts 2 (see also FIG. 4). The material bridge 5 has the same layered structure as the region of the interior panel part 1 surrounding it. Since the wedge shape of the material bridge 5 is oriented so that its tip is pointing towards the visible surface 11 of the interior panel part 1, the relatively broad base of the wedge-shaped material bridge 5 is disposed in the base layer 8. The advantage of this is that the material bridge 5 is able to hold the air bag flap 6 in a relatively stable arrangement within the interior panel part 1. In addition, however, the air bag flap 6 is joined to the region of the interior panel part 1 surrounding it by the entire wedge-shaped material bridge 5. A join also exists via the outer layer 10. However, since this outer layer 10 is thin and flexible, the contribution which the outer layer 10 makes to the attachment of the air bag flap is pretty much negligible. Instead, the continuous outer layer 10 ensures that the air bag flap 6 is invisible as viewed from the visible surface 11 of the interior panel part 1 because it does not stand out or differ from the remaining region of the interior panel part 1. The exact shape of the wedge-shaped material bridge 5 will be explained again in more detail below with reference to FIG. 4.

Firstly, however, FIG. 3 illustrates a part of the hinge portion 7 of the interior panel part 1. As already explained, the hinge portion 7 is formed at a point where a series of perforation-shaped cuts or recesses 4 is provided on the internal face of the interior panel part 1. In the embodiment illustrated in FIG. 3, these perforation-shaped cuts 4 are cylindrical in shape. They extend through the base layer 8, through the foam layer 9 and into the outer layer 10. Consequently, they are of the same depth T as the linear cuts 2 illustrated in FIG. 2. Due to the cylindrical shape of the perforation-shaped cuts 4, the material bridges 5 lying between these cuts 4 do not have undercuts. Nevertheless, it would be conceivable to provide the material bridges 5 between the perforation-shaped cuts 4 with undercuts as well. On the internal face of the interior panel part 1, i.e. on the base layer 8, the perforation-shaped cuts 4 could thus retain their circular shape.

FIG. 4 illustrates a vertical section through the interior panel part 1 proposed by the invention at the point denoted by IV-IV in FIG. 1, i.e. along the breaking line 3. A part of a device for producing the interior panel part 1 is also schematically illustrated.

As explained above, the interior panel part 1 consists of a strong base layer 8, a foam layer 9 and an outer layer 10. The original total thickness of the interior panel part 1 is denoted by D in FIG. 2. Since the cuts 2, 4 extend into the outer layer 10, the material thickness d in this region is slimmer than the material thickness of the outer layer 10 alone.

The material bridge 5 between two linear cuts 2 illustrated in FIG. 4 has undercuts 12 on its two sides facing the cuts 2, i.e. in the longitudinal direction of the breaking line 3. The material bridge 5 illustrated in this instance is wedge-shaped and the tip 13 of the wedge is directed towards the visible surface 11 of the interior panel part 1. Both undercuts 12 have a respective angle α of approximately 10°. Since the undercuts 12 are of the same angle α, the material bridge 5 is symmetrical with respect to a mid-plane 14 extending perpendicular to the layers 8, 9, 10 of the interior panel part 1. Such a symmetrical shape of the material bridges 5 results in a particularly appropriate distribution of forces when the air bag is released and thus enables the interior panel part 1 to tear open easily along the breaking line 3.

FIG. 4 provides a schematic illustration of a device for manufacturing the interior panel part 1 proposed by the invention. This device has a laser 15, for example a CO₂ laser. The laser beam 16 emitted by this laser 15 is concentrated by means of a focussing system 17. A scanner mirror system 18 with at least one mirror 20 which can be pivoted about an axis 19 directs the laser beam 16 so that its focal point 21 lies in the interior of the pre-formed interior panel part 1 of layered material. Material is removed at the focal point 21 of the laser beam 16. The cuts 2 can be produced to the desired depth T in this manner.

In the position illustrated by solid lines, the laser beam 16 hits the interior panel part 1 at an angle. This enables the undercuts 12 to be produced on the material bridges 5. The focal point 21 of the laser beam 16 in this instance lies in the interior panel part 1 at the depth T.

The broken lines illustrate a different position of the scanner mirror 20 in which the laser beam 16 hits the interior panel part 1 vertically. The focussing system 17 can be adjusted (for example by moving a focussing lens into the position likewise illustrated by broken lines) so that the focal point 21 of the laser beam also lies at the same depth T when the laser beam 16 hits the interior panel part 1 vertically. This enables the cuts 2 to be produced with a constant depth T across their entire length. It would also be conceivable to move or adjust the focussing system 17 into a position in which the focal point 21 of the laser beam 16 is in the base layer 8 first of all and then move it from there farther down in order to produce an approximately perforation-shaped cut 4 in the interior panel part 1 or in order to cut into the interior panel part 1 slowly.

Naturally, a sensor system may be provided on the device for manufacturing the interior panel part 1 proposed by the invention, which monitors the position of the laser's focal point 21 in the interior panel part 1 and the processing result.

As already explained, the wedge shape of the material bridges 5 not only ensures that the air bag flap 6 is securely attached to the interior panel part 1 but also ensures that the air bag flap 6 will open safely and reliably when the air bag is released. As soon as the air bag hits the air bag flap 6, the latter is pushed outwards out of the interior panel part 1. As this happens, the material bridge 5 is subjected to a shearing motion. Since the tip 13 of the material bridge 5 is relatively slim, in addition to the fact that the outer layer 10 is made from flexible material, this shearing motion causes the material bridge 5 to tear at its tip 13. At the same time, the material bridge 5 moves obliquely due to the shearing motion and thus forms a tip facing the outer layer 10. It is able to piece the outer layer 10 by means of this tip and thus causes the entire breaking line 3 to tear open. The air bag flap 6 then pivots about the hinge portion 7 and exposes an opening through which the air bag is able to unfold in the passenger compartment.

Starting with the embodiment described as an example, the interior panel part proposed by the invention can be modified in numerous ways. For example, the undercuts 12 may be provided with a different angle α or they may be provided on one side of the material bridges 5 only. The material bridges 5 between the perforation-shaped cuts 4 may also have undercuts 12. The breaking line 3 is not restricted to the U-shaped contour illustrated but may also be of any other shape. Other variations would also be conceivable, for example in terms of the layered structure of the interior panel part 1, which is also not limited to the embodiment specifically described here.

What is claimed is:

1. Interior panel part for motor vehicles, with at least one breaking line for exposing an opening when an air bag is released, which breaking line is defined by cuts on the side of the panel part lying opposite a visible surface, and material bridges are also provided between these cuts, characterised in that at least one of the material bridges is wedge-shaped so that it has an undercut in the direction of the breaking line, and the slim end of the wedge shape is directed towards the visible surface of the panel part.

2. Interior panel part as in claim 1, characterised in that the material bridge has undercuts in the direction of the breaking line on its two sides.

3. Interior panel part as in claim 1, characterised in that the material bridge is symmetrical so that its mid-plane is specifically oriented perpendicular to the visible surface of the interior panel part.

4. Interior panel part as in claim 1, characterised in that at least one undercut has an undercut angle of between 3° and 20°, preferably between 5° and 15°.

5. Interior panel part as in claim 1, characterised in that the thickness of the panel part at a material bridge is of exactly the same size as in the regions outside of the cuts.

6. Interior panel part as in claim 1, characterised in that it comprises several layers of different materials, in particular a base layer, a foam layer and/or an outer layer.

7. Interior panel part as in claim 1, characterised in that the material bridge has the same arrangement of material layers as the adjacent region of the panel part.

8. Interior panel part as in claim 1, characterised in that the material bridge is made from a different material than the adjacent region of the panel part.

9. Interior panel part as in claim 1, characterised in that it has a strong base layer and the base of the material bridge is made from the material of the base layer.

10. Interior panel part as in claim 1, characterised in that it has an outer layer forming the visible surface and a cut extends at least in certain portions as far as or into the outer layer.

11. Interior panel part as in claim 1, characterised in that a hinge portion for an air bag flap is provided between two points of the breaking line.

12. Interior panel part as in claim 1, characterised in that cuts of differing lengths are provided along the breaking line.

13. Interior panel part as in claim 1, characterised in that perforation-shaped and/or linear cuts are provided along the breaking line.

14. Interior panel part as in claim 1, characterised in that the breaking line is approximately U-shaped and has linear cuts, whereas a hinge portion with peroration-shaped cuts is provided between the two end points of the U-shaped breaking line.

15. Interior panel part as in claim 1, characterised in that each cut has a constant depth.

16. Method of manufacturing an interior panel part for motor vehicles, whereby a tool produces cuts on the side of the interior panel part lying opposite a visible surface in order to define a breaking line for exposing an opening when an air bag is released, and material bridges are also left between the cuts, characterised in that the tool produces an undercut in the direction of the breaking line on at least one material bridge so that the material bridge is approximately wedge-shaped.

17. Method as in claim 16, characterised in that a laser beam is used as the tool in order to remove material from the panel part along the cuts.

18. Method as in claim 17, characterised in that a scanner mirror system is provided in order to vary the orientation of the laser beam relative to the interior panel part in order to produce the undercuts.

19. Method as in claim 16, characterised in that an adjustable focussing system is provided for the laser beam, by means of which the focal point of the laser beam can be held at a constant depth in the interior panel part when producing the cuts.
